(19) United States
(12) Patent Application Publication
(10) Pub. No.: US 2023/0010692 A1
(43) Pub. Date: Jan. 12, 2023

(54) Performance Degradation Reporting in a Microwave System

(71) Applicant: Telefonaktiebolaget LM Ericsson (publ), Stockholm (SE)

(72) Inventors: Martin Sjödin, Göteborg (SE); Jonas Hansryd, Göteborg (SE); Stefan Håkansson, Göteborg (SE); Patrik Olesen, Floda (SE)

(21) Appl. No.: 17/782,264

(22) PCT Filed: Dec. 9, 2019
(86) PCT No.: PCT/EP2019/084144

§ 371 Date: Jun. 3, 2022

(51) Int. Cl. H04B 17/309; H04W 24/02

(52) U.S. Cl. CPC H04B 17/309; H04W 24/02

(57) ABSTRACT

Mechanisms for performance degradation reporting in a microwave system, which comprises a point-to-point wireless microwave link, are provided. A method is performed by a controller entity. The method comprises obtaining classified microwave link data. The classified microwave link data represents microwave link data of the point-to-point wireless microwave link as classified to operating conditions in a set of operating conditions. The method comprises detecting performance degradation affecting data throughput in the microwave system by analysing performance data of the point-to-point wireless microwave link. The method comprises determining, by using the performance data and cause of the performance degradation that attention from an operator entity in the microwave system is required. The cause is defined by the microwave link data as classified to the operating conditions. The method comprises providing an indication to the operator entity only when attention from the operator entity is required. The indication is an indication of the performance degradation and the cause of the performance degradation.

### TECHNICAL FIELD

Embodiments presented herein relate to a method, a controller entity, a computer program, and a computer program product for performance degradation reporting in a microwave system comprising a point-to-point wireless microwave link.

### BACKGROUND

In a microwave system digital information is sent over point-to-point wireless microwave links between two nodes. These two nodes are typically spaced from a few hundred meters up to several kilometers. Each node comprises link equipment, such as an antenna, a radio for frequency up- and down-conversion, and a modem for digital signal processing, used for transmission and reception of microwave signals over the point-to-point wireless microwave links.

Point-to-point wireless microwave links are sometimes subjected to disturbances. Such disturbances affect the received signal power and quality. This might trigger alarms that are sent to the network operator. When a network operator suspects that the link equipment is not working properly, a common response is to make a site visit (i.e., to send maintenance personnel to inspect the link equipment). Such a site visit sometimes results in the link equipment, or at least part thereof, being shipped back to the manufacturer for maintenance, or even replacement.

It has been found during inspections that a significant fraction of the link equipment sent back to the manufacturer in fact does not suffer from impaired operation and no faults are found. This indicates that resources, such as time and money, might be saved if network operators are provided with more accurate feedback about their network equipment.

As microwave system often comprises hundreds, or even thousands, of microwave links, providing such accurate feedback in an efficient manner could be challenging.

Hence, there is a need for providing accurate feedback in an efficient manner when performance degradation of a point-to-point wireless microwave link has occurred in a microwave system.

### SUMMARY

An object of embodiments herein is to enable efficient and accurate feedback when performance degradation of a point-to-point wireless microwave link occurs in a microwave system.

According to a first aspect there is presented a method for performance degradation reporting in a microwave system comprising a point-to-point wireless microwave link. The method is performed by a controller entity. The method comprises obtaining classified microwave link data. The classified microwave link data represents microwave link data of the point-to-point wireless microwave link as classified to operating conditions in a set of operating conditions. The method comprises detecting performance degradation affecting data throughput in the microwave system by analysing performance data of the point-to-point wireless microwave link. The method comprises determining, by using the performance data and cause of the performance degradation that attention from an operator entity in the microwave system is required. The cause is defined by the microwave link data as classified to the operating conditions. The method comprises providing an indication to the operator entity only when attention from the operator entity is required. The indication is an indication of the performance degradation and the cause of the performance degradation.

According to a second aspect there is presented a controller entity for performance degradation reporting in a microwave system comprising a point-to-point wireless microwave link. The controller entity comprises processing circuitry. The processing circuitry is configured to cause the controller entity to obtain classified microwave link data. The classified microwave link data represents microwave link data of the point-to-point wireless microwave link as classified to operating conditions in a set of operating conditions. The processing circuitry is configured to cause the controller entity to detect performance degradation affecting data throughput in the microwave system by analysing performance data of the point-to-point wireless microwave link. The processing circuitry is configured to cause the controller entity to determine, by using the performance data and cause of the performance degradation that attention from an operator entity in the microwave system is required. The cause is defined by the microwave link data as classified to the operating conditions. The processing circuitry is configured to cause the controller entity to provide an indication to the operator entity only when attention from the operator entity is required. The indication is an indication of the performance degradation and the cause of the performance degradation.

According to a third aspect there is presented a controller entity for performance degradation reporting in a microwave system comprising a point-to-point wireless microwave link. The controller entity comprises an obtain module configured to obtain classified microwave link data. The classified microwave link data represents microwave link data of the point-to-point wireless microwave link as classified to operating conditions in a set of operating conditions. The controller entity comprises a detect module configured to detect performance degradation affecting data throughput in the microwave system by analysing performance data of the point-to-point wireless microwave link. The controller entity comprises a determine module configured to determine, by using the performance data and cause of the performance degradation that attention from an operator entity in the microwave system is required. The cause is defined by the microwave link data as classified to the operating conditions. The controller entity comprises a provide module configured to provide an indication to the operator entity only when attention from the operator entity is required. The indication is an indication of the performance degradation and the cause of the performance degradation.

According to a fourth aspect there is presented a computer program for performance degradation reporting in a microwave system comprising a point-to-point wireless microwave link, the computer program comprising computer program code which, when run on a controller entity, causes the controller entity to perform a method according to the first aspect.

According to a fifth aspect there is presented a computer program product comprising a computer program according to the fourth aspect and a computer readable storage medium on which the computer program is stored. The computer readable storage medium could be a non-transitory computer readable storage medium.

Advantageously these aspects provide efficient and accurate feedback when performance degradation of the point-to-point wireless microwave link occurs in the microwave system.

Advantageously these aspects enable feedback to be sent to network operators only for events that affect the end-user experience and should be investigated on a short notice.

Advantageously these aspects enable detection of disturbances and distinguish between different operating conditions for microwave links with high accuracy and enable gathering of as detailed and accurate information as possible about the performance degradation and its cause.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a microwave system according to embodiments;

FIGS. 2 and 4 are flowcharts of methods according to embodiments;

FIG. 3 schematically illustrates mapping between microwave link data values and operating condition probabilities according to an embodiment;

FIG. 5 schematically illustrates simulation results according to embodiments;

FIG. 6 is a schematic diagram showing functional units of a controller entity according to an embodiment;

FIG. 7 is a schematic diagram showing functional modules of a controller entity according to an embodiment; and

FIG. 8 shows one example of a computer program product comprising computer readable storage medium according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

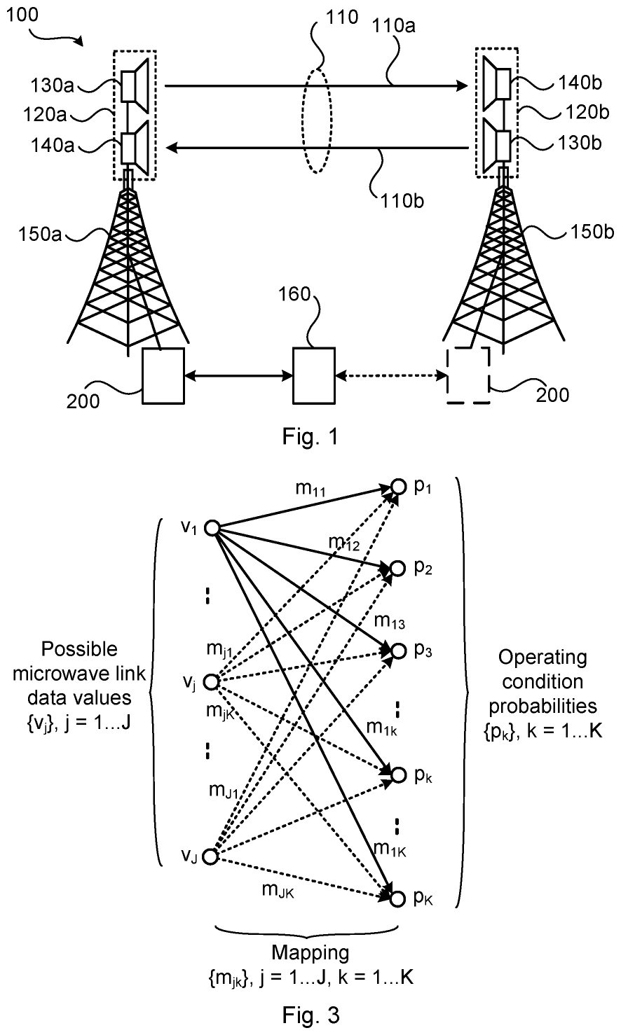

FIG. 1 is a schematic diagram illustrating a microwave system 100 where embodiments presented herein can be applied. The microwave system 100 comprises two nodes 120a, 120b configured to communicate with each other over point-to-point wireless microwave links 110, 110a, 110b. In turn, each node 120a, 120b comprises a microwave signal transmitter 130a, 130b configured for transmission of microwave link data in signals, and a microwave signal receiver 140a, 140b configured for reception of microwave link data in signals. Each node 120a, 120b might be part of a respective site 150a, 150b. Each site 150a, 150b is, via a controller entity 200, operatively connected to an operator entity 160. Further aspects of the controller entity 200 will be disclosed below.

The embodiments disclosed herein relate to mechanisms for performance degradation reporting in a microwave system 100 comprising a point-to-point wireless microwave link 110, 110a, 110b. In order to obtain such mechanisms there is provided a controller entity 200, a method performed by the controller entity 200, a computer program product comprising code, for example in the form of a computer program, that when run on a controller entity 200, causes the controller entity 200 to perform the method.

Operator entity 160 denotes, according to some aspects, an entity responsible for the actual operation of the microwave system 100, i.e. the entity responsible for taking action when the system's performance is not up to par. It can for example be an entity with which personnel in the network operating center (NOC) might interact, an entity running a computer program which in some examples is capable of employing machine learning techniques and/or handling traffic routing through the microwave system 100 or similar.

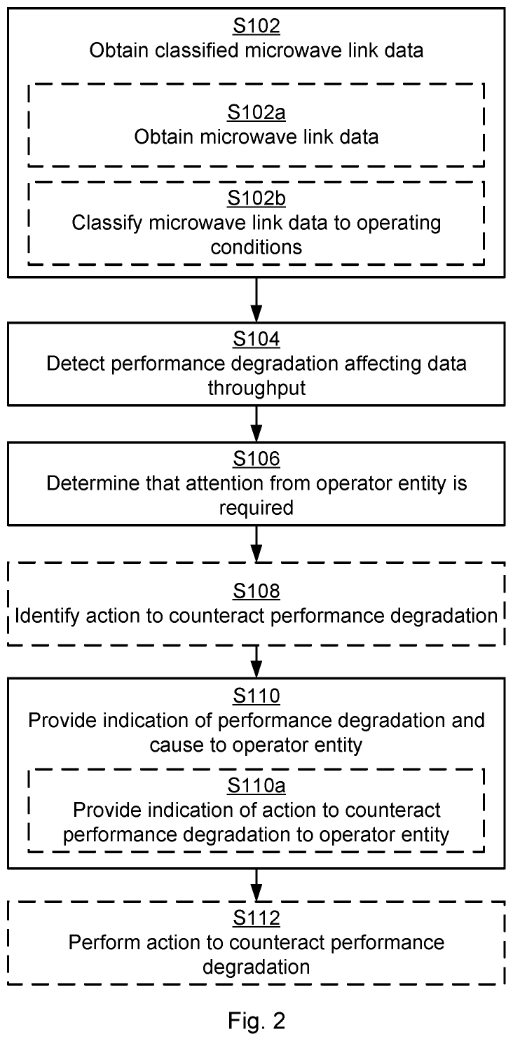

FIG. 2 is a flowchart illustrating embodiments of methods for performance degradation reporting in a microwave system 100 comprising a point-to-point wireless microwave link 110, 110a, 110b. The methods are performed by the controller entity 200. The methods are advantageously provided as computer programs 820.

The performance degradation reporting is based on microwave link data of the microwave system 100. Hence, the controller entity 200 is configured to perform S102:

S102: The controller entity 200 obtains classified microwave link data. The classified microwave link data represents microwave link data of the point-to-point wireless microwave link 110, 110a, 110b as classified to operating conditions in a set of operating conditions.

One issue is that if the microwave link data has been classified with high sensitivity and such classified microwave link data is used as operator feedback, there is a risk that large numbers of events that are not critical for the performance of the point-to-point wireless microwave link 110, 110a, 110b in the sense that events that do not affect data throughput are reported to the operator entity 160. On the other hand, if the sensitivity according to which the microwave link data is classified is too low, the ability to distinguish between different types of operating conditions is reduced. This tradeoff is circumvented by basing the operator feedback both on the classified microwave link data and performance data of the microwave system 100. In particular, the controller entity 200 is configured to perform S104:

S104: The controller entity 200 detects performance degradation affecting data throughput in the microwave system 100. The performance degradation is detected by the controller entity 200 analysing performance data of the point-to-point wireless microwave link 110, 110a, 110b.

The output from the classification in step S102 and the output of the performance detection in step S104 are used as input to step S106. In particular, the controller entity 200 is configured to perform S106:

S106: The controller entity 200 determines, by using the performance data and the cause of the performance degradation that attention from an operator entity 160 in the microwave system 100 is required. The cause is defined by the microwave link data as classified to the operating conditions.

Operator feedback is then provided only on a per need basis. In particular, the controller entity 200 is configured to perform S110:

S110: The controller entity 200 provides an indication to the operator entity 160 only when attention from the operator entity 160 is required, wherein the indication is an indication of the performance degradation and the cause of the performance degradation.

Advantageously this method provides efficient and accurate feedback when performance degradation of the point-to-point wireless microwave link 110, 110a, 110b occurs in the microwave system 100.

Advantageously this method enables feedback to be sent to network operators only for events that affect the end-user experience and should be investigated on a short notice.

Advantageously this method enables detection of disturbances and distinguish between different operating conditions for microwave links 110, 110a, 110b with high accuracy and enable gathering of as detailed and accurate information as possible about the performance degradation and its cause.

Embodiments relating to further details of performance degradation reporting in a microwave system 100 comprising a point-to-point wireless microwave link 110, 110a, 110b as performed by the controller entity 200 will now be disclosed.

The operator entity 160 might be configured to select, or to receive input regarding such a selection, what information that in S110 should be reported from the controller entity 200 to the operator entity 160. Further aspects relating thereto will be disclosed below. A user might thereby interact with the operator entity 160 and thereby determine what kind of indications that are to be provided from the controller entity 200 to the operator entity 160.

That is, in some embodiments, the indication is in S110 provided to the operator entity 160 upon the controller entity 200 has verified that the operator entity 160 has requested to receive such an indication.

In some embodiments the microwave link data has been classified on a time window basis, i.e. the data comprises sequences of samples acquired within a given time interval. The performance data might then be analyzed only once per each time window. There could be different lengths of the time window. In some examples, each of the time windows has a length of at least 1 minute and up to one or more years, such as between 1 minute and 1 year, such as between 1 minute and 1 month, such as between 1 minute and 1 week, such as between 1 minute and 1 day, such as between 1 minute and 12 hours, such as between 1 hour and 6 hours. In each time window, the microwave link data might be sampled in the order of every 10 seconds. The microwave link data might thus be time series data that is sampled over 1 to 6 hours with 10 seconds resolution.

There could be different scenarios during which the performance degradation detection and reporting is performed. In some examples, the performance degradation is detected during network operation of the microwave system 100.

Microwave data link values related to the operation and performance of a point-to-point wireless microwave link 110, 110a, 110b can be extracted from the microwave signal receivers 140a, 140b, the microwave signal transmitter 130a, 130b, or other radio equipment, in the nodes 120a, 120b. Examples of microwave link data are signal quality measurement values, received power values, transmitted power values, power attenuation values, equalizer tap values, or any combination thereof. In general terms, equalizer tap values refer to the real and imaginary parts of the taps of the digital filter used in the receiver for channel equalization, i.e., the digital filter used to reverse the distortion introduced by the wireless channel affecting the wireless microwave link 110, 110a, 110b, the microwave signal receivers 140a, 140b, the microwave signal transmitter 130a, 130b, or other radio equipment, in the nodes 120a, 120b.

There could be different examples of performance data that is analyzed by the controller entity 200 in S104. In some non-limiting examples, the performance data pertains to packet-error rate, bit error rate, modulation state data, any combination thereof, or any other performance data that can be used to check if the throughput is affected by current operating conditions, e.g., if the operating conditions are such that the rate of transmitted bits of any of the point-to-point wireless microwave links 110, 110a, 110b is reduced.

In some aspects, the controller entity 200 by itself, and upon having detected the performance degradation, seeks to mitigate, or otherwise reduce the impact of, the performance degradation. Hence, according to an embodiment, the controller entity 200 is configured to perform (optional) step S108:

S108: The controller entity 200 identifies at least one action to counteract the performance degradation.

There could be different types of actions, for example depending on the cause of the performance degradation, which type of performance degradation is experienced, and/or how severe, or intense, the performance degradation is (i.e., how much the performance degradation affects the throughput). Thus, in some embodiments, the at least one action is identified based on the cause of the performance degradation and at least one of type and intensity of the performance degradation.

There might be some performance degradations that cannot be counteracted by the controller entity 200, such as if the nodes 120a, 120b, sites 150a, 150b, or parts thereof, suffer from performance degradation as a result of having been physically damaged, or the like. In some aspects, the thus identified at least one action is reported to the operator entity 160. Hence, according to an embodiment, the controller entity 200 is configured to perform (optional) step

S110a as part of S110:

S110a: The controller entity 200 provides an indication of the at least one action to the operator entity 160.

In some aspects the at least one action pertains to long-term improvement of the nodes 120a, 120b, sites 150a, 150b, or parts thereof. For example, if performance degradation for a point-to-point wireless microwave link 110, 110a, 110b is found to correlate with windy operating conditions the point-to-point wireless microwave link 110, 110a, 110b might perform better if a more robust mast is used, or if smaller antennas are used, etc. Another example is that microwave signal transmitters 130a, 130b and microwave signal receivers 140a, 140b that often get covered with snow might be provided with a heating system, etc. That is, in some embodiments, the indication is in S110a provided only after the controller entity 200 having determined that the performance degradation affects the data throughput longer than a time threshold value.

There might be some performance degradations that indeed can be counteracted by the controller entity 200. In some aspects, the thus identified at least one action is performed by the controller entity 200. Hence, according to an embodiment, the controller entity 200 is configured to perform (optional) step S112:

S112: The controller entity 200 performs the at least one action (as identified in S108).

The controller entity 200 might thus be configuring for self-healing of the microwave system 100.

There could be different types, and different number, of operating conditions. According to an embodiment, there are at least three operating conditions in the set of operating conditions. One operating condition pertains to normal operation of the point-to-point wireless microwave link 110, 110a, 110b. At least two operating conditions pertain to performance degraded operation of the point-to-point wireless microwave link 110, 110a, 110b. Non-limiting illustrative examples of operating conditions and properties thereof are summarized next.

Normal operation: The transmission is not affected by any significant disturbances. The power attenuation, or received power, is essentially flat per each time window. The mean square error (MSE) is lower than (approximately) −35 dB, the signal power before and after digital channel filter in the receiver is the same, and the impulse response of the equalizer filter resembles a spike.

Rain: The signal is attenuated because of scattering from precipitation. The power attenuation is increased. The received power decreases if the transmitted power remains constant. If the transmitted power is increased in order to compensate for the increased power attenuation, the received power remains constant if enough transmit power is available to fully compensate for the increase in attenuation, or decreases if the transmitter can only partially compensate for the increase in attenuation. The MSE may be degraded depending on the received power. The signal power before and after channel filtering is the same, and the impulse response of the equalizer filter should resemble a spike.

Intermittent obstruction: Objects in the signal path cause additional attenuation. The power attenuation, or received power, is varying over time. The MSE may be degraded depending on the received power. The signal power before and after channel filtering is the same, and the impulse response of the equalizer filter should resemble a spike.

Multipath propagation: Power fluctuations occur due to interference when signal energy propagates along different paths between the microwave signal transmitter 130a, 130b and the microwave signal receiver 140a, 140b. The power attenuation, or received power, is varying over time. The attenuation might be reduced compared to during normal operating conditions, if the signals taking different paths interfere constructively in the microwave signal receiver 140a, 140b. The signal power before and after channel filtering is the same. The impulse response of the equalizer filter depends on the multipath conditions but will have a broader response compared to during normal conditions. The MSE might be degraded even if the signal power is sufficient to achieve good performance during normal conditions. If data from both transmission directions is included, it is highly likely that the operating conditions for both transmission directions are the same.

Maintenance: The link is down or at very low power for more than 5 minutes. The received power is reduced to comparatively very low levels for more than 5 minutes. Conversely, the power attenuation is increased to comparatively very high levels for more than 5 minutes.

Restart: The link is down or at very low power for less than 5 minutes. The received power is reduced to comparatively very low levels for less than 5 minutes. Conversely, the power attenuation is increased to comparatively very high levels for less than 5 minutes.

Mast sway: The received power fluctuates due to sway of the site 150a, 150b. The sway could be due to e.g. to wind load or mast bending due to heat. The power attenuation, or received power, is varying over time. The MSE might drop from its normal level depending on the received power. The signal power before and after channel filtering is the same, and the impulse response of the equalizer filter should resemble a spike.

Snow: The received power is reduced due to snow covering the microwave signal transmitter 130a, 130b and/or the microwave signal receiver 140a, 140b. The power attenuation, or received power, is varying over time. The MSE might drop from its normal level depending on the received power. The signal power before and after channel filtering is the same, and the impulse response of the equalizer filter should resemble a spike.

Vegetation: The received power is reduced due to season varying vegetation. Such as leaves or other type of foliage falling or snow covering trees or other types of foliage. The MSE might drop from its normal level depending on the received power.

Interference from other microwave links: The receive power should increase or be similar to that of normal operation. Conversely, the power attenuation should decrease or be similar to that of normal operation. The MSE increases from its normal level depending on the power and spectral content of the interfering signal. The signal power before and after channel filtering will be different if the interferer is located out-of-band or partly out-of-band. The equalizer response will resemble a spike. If data from both transmission directions is included, it is highly likely that the operating conditions are different from each other in the different transmission directions.

As disclosed above, the controller entity 200 in S102 obtains classified microwave link data. Further aspects relating thereto will now be disclosed.

Microwave data link values related to the operation and performance of a point-to-point wireless microwave link 110, 110a, 110b can be extracted from the microwave signal receivers 140a, 140b, the microwave signal transmitter 130a, 130b, or other radio equipment, in the nodes 120a, 120b. Examples of microwave link data are transmitted power level of the signal transmitted from a node, the received power of the signal received from another node, MSE of the demodulated signal, the signal power before and after channel filtering, equalizer tap values, etc.

In particular, according to an embodiment, the controller entity 200 is configured to perform (optional) step S102a as part of step S102:

S102a: The controller entity 200 obtains, in time windows, microwave link data in terms of signal quality measurement values and received power values for the point-to-point wireless microwave link 110, 110a, 110b.

The microwave link data is then, per each time window, classified to operating conditions. In particular, according to an embodiment, the controller entity 200 is configured to perform (optional) step S102b as part of step S102:

S102b: The controller entity 200 classifies, per time window, the microwave link data per time window to operating conditions in a set of operating conditions by, from the signal quality measurement values and received power values per time window, estimating probability values {pₖ} for each of the operating conditions according to a mapping {mⱼₖ}, as learned through training, between pieces of microwave link data and operating conditions.

The output from the classification in step S102b is then used as input to step S106.

In some aspects, the microwave link data in the time windows further comprises transmitted power values for the point-to-point wireless microwave link 110, 110a, 110b. According to an embodiment, the microwave link data per time window is, according to the mapping {mⱼₖ}, classified also from the transmitted power values in that time window.

In some aspects, one respective power attenuation value is determined from each pair of transmitted power value and received power value. It is understood that each pair of values contains values that are valid for the same point in time. According to an embodiment, the microwave link data per time window is, according to the mapping {mⱼₖ}, classified from the power attenuation values.

The training process for learning the mapping {mⱼₖ} is based on feeding large numbers of data examples representing different operating conditions to a classifier, as implemented by, or operatively connected to, the controller entity 200. Eventually the classifier learns to associate different input data patterns of the microwave link data with different operating conditions.

Training processes such as the one exemplified above are often referred to as “supervised learning” and are examples of well-known machine learning approaches. In another example, the mapping {mⱼₖ} can be learned through other machine learning approaches such as “reinforcement learning” or “unsupervised learning”, or by any combination of supervised learning, reinforcement learning and unsupervised learning.

FIG. 3 schematically illustrates a mapping {mⱼₖ} from J possible microwave link data values {vⱼ}, j=1 . . . J, to K operating condition probability values {pₖ}, k=1 . . . K.

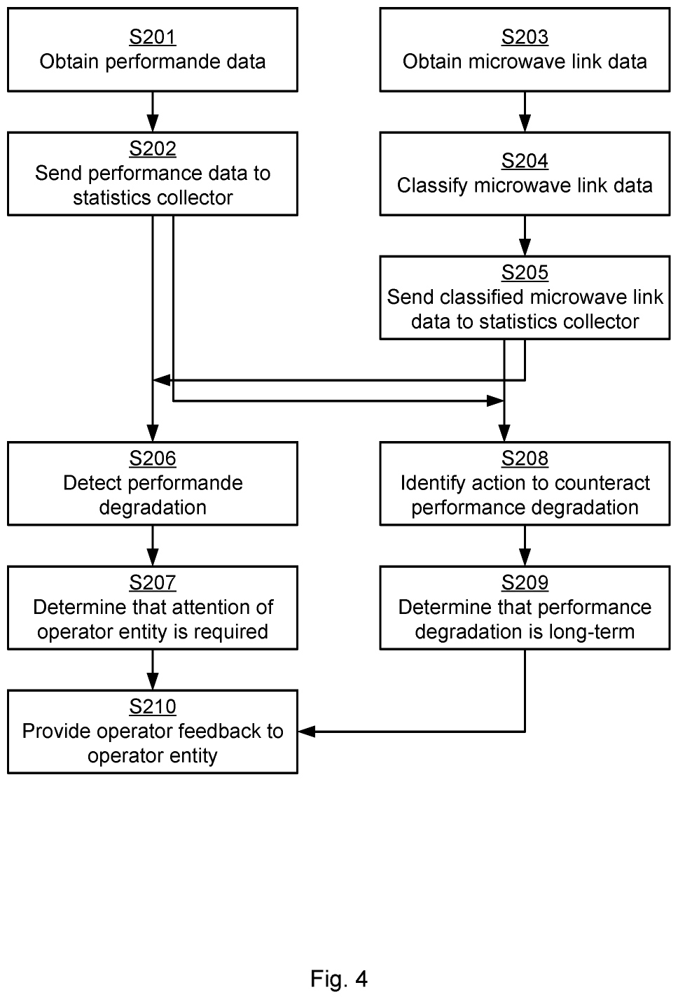

One particular embodiment of a method for performance degradation reporting in a microwave system 100 comprising a point-to-point wireless microwave link 110, 110a, 110b as performed by a controller entity 200 based on at least some of the above disclosed embodiments, aspects, and examples will now be disclosed with reference to the flowchart of FIG. 4.

S201: Performance data of the point-to-point wireless microwave link 110, 110a, 110b is obtained.

S202: The performance data is sent to a statistics collector.

S203: Microwave link data for the same point-to-point wireless microwave link 110, 110a, 110b as for which the performance data was obtained in step S201 is obtained, as in S102a.

S204: The obtained microwave link data is classified, as in S102b.

S205: The thus classified microwave link data is sent to a statistics collector

S206: Performance degradation affecting data throughput in the microwave system 100 is detected, as in S104, for example by detecting bit errors, packet errors, or modulation changes.

S207: By using the performance data and the cause of the performance degradation it is determined that attention from the operator entity 160 in the microwave system 100 is required, as in S106. The cause is defined by the microwave link data as classified to the operating conditions.

S208: At least one action to counteract the performance degradation is identified, as in S108, based on the cause of the performance degradation and at least one of type and intensity of the performance degradation. Such actions can be identified as a precaution even if a point-to-point wireless microwave link 110, 110a, 110b has not yet suffered from any performance degradations due to the disturbance or operating condition.

S209: It is determined that that the performance degradation is long-term and thus affects the data throughput longer than a time threshold value.

S210: Operator feedback is provided to the operator entity 160, as in S110. The feedback information will inform the operator entity 160 that the point-to-point wireless microwave link 110, 110a, 110b is experience performance degradation. Also the most likely cause of the performance degradation, and an indication of an action might be provided, as in S110a.

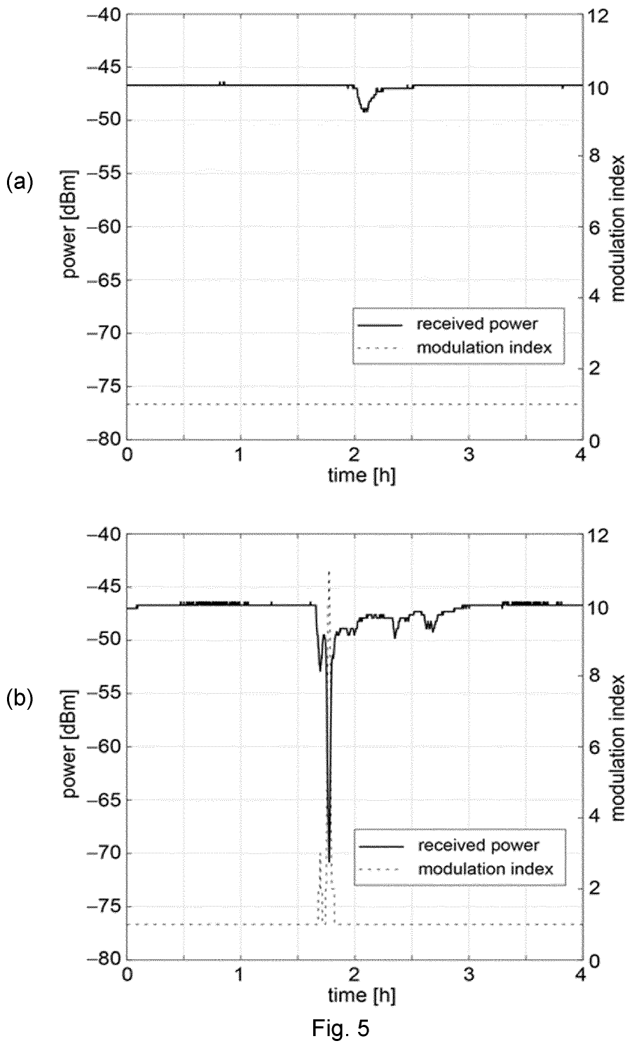

FIG. 5(a) illustrates simulation results of a scenario where the microwave link data has been classified as rainy operation conditions. Since the performance data, in the form of a reference index for the modulation state, does not indicate any performance degradation, the event does not need to be reported to the operator entity 160. A modulation index of 1 denotes the highest order of modulation for the point-to-point wireless microwave link 110, 110a, 110b, and the index increases by 1 for every reduction of the modulation state.

FIG. 5(b) illustrates simulation results of a scenario where the microwave link data has been classified as rainy operation conditions. However, in contrast to the example of FIG. 5(a), the performance data shows that modulation state changes have occurred, resulting in a reduction of the throughput of the point-to-point wireless microwave link 110, 110a, 110b. An indication of the performance degradation and the cause of the performance degradation is therefore indicated to the operator entity 160 as in S106.

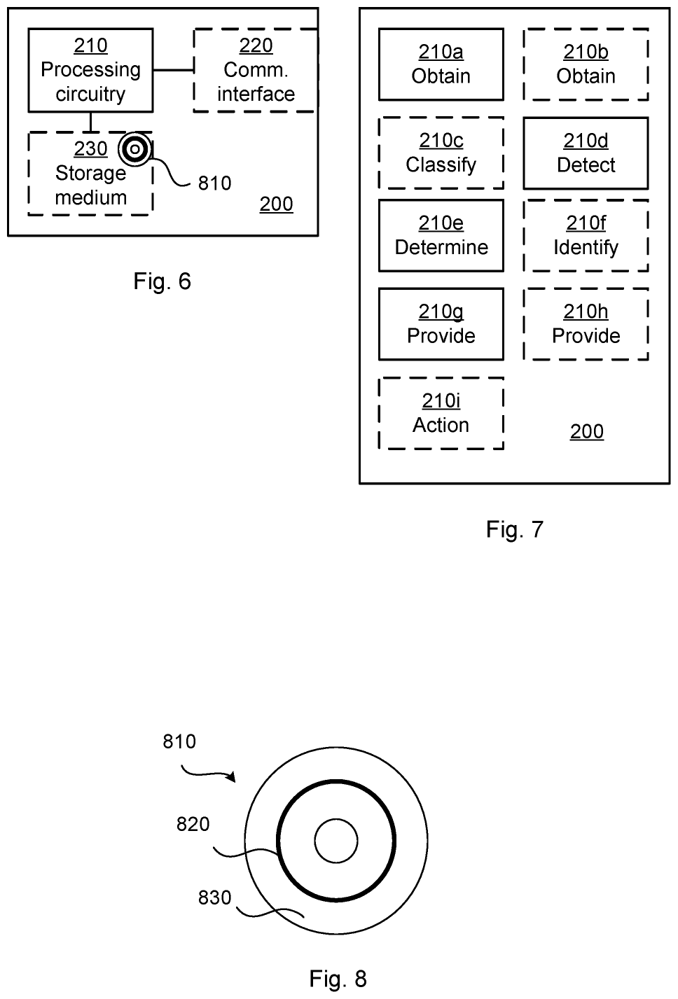

FIG. 6 schematically illustrates, in terms of a number of functional units, the components of a controller entity 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 810 (as in FIG. 8), e.g. in the form of a storage medium 230. The processing circuitry 210 may further be provided as at least one application specific integrated circuit (ASIC), or field programmable gate array (FPGA).

Particularly, the processing circuitry 210 is configured to cause the controller entity 200 to perform a set of operations, or steps, as disclosed above. For example, the storage medium 230 may store the set of operations, and the processing circuitry 210 may be configured to retrieve the set of operations from the storage medium 230 to cause the controller entity 200 to perform the set of operations. The set of operations may be provided as a set of executable instructions.

Thus the processing circuitry 210 is thereby arranged to execute methods as herein disclosed. The storage medium 230 may also comprise persistent storage, which, for example, can be any single one or combination of magnetic memory, optical memory, solid state memory or even remotely mounted memory. The controller entity 200 may further comprise a communications interface 220 at least configured for communications with other entities, functions, nodes, and devices of the microwave system 100. As such the communications interface 220 may comprise one or more transmitters and receivers, comprising analogue and digital components. The processing circuitry 210 controls the general operation of the controller entity 200 e.g. by sending data and control signals to the communications interface 220 and the storage medium 230, by receiving data and reports from the communications interface 220, and by retrieving data and instructions from the storage medium 230. Other components, as well as the related functionality, of the controller entity 200 are omitted in order not to obscure the concepts presented herein.

FIG. 7 schematically illustrates, in terms of a number of functional modules, the components of a controller entity 200 according to an embodiment. The controller entity 200 of FIG. 7 comprises a number of functional modules; an obtain module 210a configured to perform step S102, a detect module 210d configured to perform step S104, a determine module 210e configured to perform step S106, and a provide module 210g configured to perform step S110. The controller entity 200 of FIG. 7 may further comprise a number of optional functional modules, such as any of an obtain module 210b configured to perform step S102a, a classify module 210c configured to perform step S102b, an identify module 210f configured to perform step S108, a provide module 210h configured to perform step S110a, and an action module 210i configured to perform step S112. In general terms, each functional module 210a-210i may in one embodiment be implemented only in hardware and in another embodiment with the help of software, i.e., the latter embodiment having computer program instructions stored on the storage medium 230 which when run on the processing circuitry makes the controller entity 200 perform the corresponding steps mentioned above in conjunction with FIG. 7. It should also be mentioned that even though the modules correspond to parts of a computer program, they do not need to be separate modules therein, but the way in which they are implemented in software is dependent on the programming language used. Preferably, one or more or all functional modules 210a-210i may be implemented by the processing circuitry 210, possibly in cooperation with the communications interface 220 and/or the storage medium 230. The processing circuitry 210 may thus be configured to from the storage medium 230 fetch instructions as provided by a functional module 210a-210i and to execute these instructions, thereby performing any steps as disclosed herein.

The controller entity 200 may be provided as a standalone device or as a part of at least one further device. For example, the controller entity 200 may be provided in one of the nodes 120a, 120b. Alternatively, functionality of the controller entity 200 may be distributed between at least two devices, or nodes. These at least two nodes, or devices, may either be part of the same network part or may be spread between at least two such network parts. According to some aspects the controller entity 200 is a logical function that can be implemented in either a more distributed fashion (e.g. co-located with the actual microwave transmitters and receivers) or in a more central fashion (e.g. in a data center).

Thus, a first portion of the instructions performed by the controller entity 200 may be executed in a first device, and a second portion of the of the instructions performed by the controller entity 200 may be executed in a second device; the herein disclosed embodiments are not limited to any particular number of devices on which the instructions performed by the controller entity 200 may be executed. Hence, the methods according to the herein disclosed embodiments are suitable to be performed by a controller entity 200 residing in a cloud computational environment. Therefore, although a single processing circuitry 210 is illustrated in FIG. 6 the processing circuitry 210 may be distributed among a plurality of devices, or nodes. The same applies to the functional modules 210a-210i of FIG. 7 and the computer program 820 of FIG. 8.

FIG. 8 shows one example of a computer program product 810 comprising computer readable storage medium 830. On this computer readable storage medium 830, a computer program 820 can be stored, which computer program 820 can cause the processing circuitry 210 and thereto operatively coupled entities and devices, such as the communications interface 220 and the storage medium 230, to execute methods according to embodiments described herein. The computer program 820 and/or computer program product 810 may thus provide means for performing any steps as herein disclosed.

In the example of FIG. 8, the computer program product 810 is illustrated as an optical disc, such as a CD (compact disc) or a DVD (digital versatile disc) or a Blu-Ray disc. The computer program product 810 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 820 is here schematically shown as a track on the depicted optical disk, the computer program 820 can be stored in any way which is suitable for the computer program product 810.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1-19. (canceled)

20. A method for performance degradation reporting in a microwave system comprising a point-to-point wireless microwave link, the method being performed by controller circuitry, the method comprising:
obtaining classified microwave link data, the classified microwave link data representing microwave link data of the point-to-point wireless microwave link as classified to operating conditions in a set of operating conditions;
detecting performance degradation affecting data throughput in the microwave system by analysing performance data of the point-to-point wireless microwave link;
determining, by using the performance data and cause of the performance degradation, that attention from an operator entity in the microwave system is required, the cause being defined by the microwave link data as classified to the operating conditions; and
providing an indication to the operator entity only when attention from the operator entity is required, wherein the indication is an indication of the performance degradation and the cause of the performance degradation.

21. The method according to claim 20, wherein the microwave link data pertains to signal quality measurement values, received power values, transmitted power values, power attenuation values, equalizer tap values, or any combination thereof.

22. The method according to claim 20, wherein the performance data pertains to packet-error rate, bit error rate, modulation state data, or any combination thereof.

23. The method according to claim 20, further comprising identifying at least one action to counteract the performance degradation.

24. The method according to claim 23, wherein the at least one action is identified based on the cause of the performance degradation and at least one of type and intensity of the performance degradation.

25. The method according to claim 23, further comprising providing an indication of the at least one action to the operator entity.

26. The method according to claim 25, wherein the indication is provided only after the controller circuitry has determined that the performance degradation affects the data throughput longer than a time threshold value.

27. The method according to claim 23, further comprising performing the at least one action.

28. The method according to claim 20, wherein the indication to the operator entity is provided once the controller circuitry has verified that the operator entity has requested to receive such an indication.

29. The method according to claim 20, wherein there are at least three operating conditions in the set of operating conditions with one operating condition pertaining to normal operation of the point-to-point wireless microwave link and at least two operating conditions pertaining to performance degraded operation of the point-to-point wireless microwave link.

30. The method according to claim 20, wherein the microwave link data has been classified on a time window basis, and wherein the performance data is analyzed only once per each time window.

31. The method according to claim 30, wherein each time window has a length of between 1 minute and 12 hours, such as between 1 hour and 6 hours.

32. The method according to claim 20, wherein the performance degradation is detected during network operation of the microwave system.

33. The method according to claim 20, wherein obtaining classified microwave data comprises:
obtaining, in time windows, microwave link data in terms of signal quality measurement values and received power values for the point-to-point wireless microwave link; and
classifying, per time window, the microwave link data per time window to operating conditions in a set of operating conditions by, from the signal quality measurement values and received power values per time window, estimating probability values ({pₖ}) for each of the operating conditions according to a mapping ({mⱼₖ}), as learned through training, between pieces of microwave link data and operating conditions.

34. Controller circuitry for performance degradation reporting in a microwave system comprising a point-to-point wireless microwave link, the controller circuitry comprising:
processing circuitry configured to cause the controller circuitry to:
obtain classified microwave link data, the classified microwave link data representing microwave link data of the point-to-point wireless microwave link as classified to operating conditions in a set of operating conditions;
detect performance degradation affecting data throughput in the microwave system by analysing performance data of the point-to-point wireless microwave link;
determine, by using the performance data and cause of the performance degradation, that attention from an operator entity in the microwave system is required, the cause being defined by the microwave link data as classified to the operating conditions; and
provide an indication to the operator entity only when attention from the operator entity is required, wherein the indication is an indication of the performance degradation and the cause of the performance degradation.

35. The controller circuitry according to claim 34, wherein the processing circuitry is further configured to cause the controller circuitry to identify at least one action to counteract the performance degradation.

36. The controller circuitry according to claim 34, wherein there are at least three operating conditions in the set of operating conditions with one operating condition pertaining to normal operation of the point-to-point wireless microwave link and at least two operating conditions pertaining to performance degraded operation of the point-to-point wireless microwave link.

37. The controller circuitry according to claim 34, wherein the microwave link data has been classified on a time window basis, and wherein the performance data is analyzed only once per each time window.

38. The controller circuitry according to claim 34, wherein to obtain the classified microwave data, the processing circuitry is configured to cause the controller circuitry to:
obtain, in time windows, microwave link data in terms of signal quality measurement values and received power values for the point-to-point wireless microwave link; and
classify, per time window, the microwave link data per time window to operating conditions in a set of operating conditions by, from the signal quality measurement values and received power values per time window, estimating probability values ({pₖ}) for each of the operating conditions according to a mapping ({mⱼₖ}), as learned through training, between pieces of microwave link data and operating conditions.

39. A non-transitory computer readable medium comprising a computer program stored thereon, the computer program comprising instructions for performance degradation reporting in a microwave system comprising a point-to-point wireless microwave link that when executed by controller circuitry, causes the controller circuitry to:
obtain classified microwave link data, the classified microwave link data representing microwave link data of the point-to-point wireless microwave link as classified to operating conditions in a set of operating conditions;
detect performance degradation affecting data throughput in the microwave system by analysing performance data of the point-to-point wireless microwave link;
determine, by using the performance data and cause of the performance degradation that attention from an operator entity in the microwave system is required, the cause being defined by the microwave link data as classified to the operating conditions; and
provide an indication to the operator entity only when attention from the operator entity is required, wherein the indication is an indication of the performance degradation and the cause of the performance degradation.
